(19) United States
(12) Patent Application Publication
(10) Pub. No.: US 2002/0105622 A1
(43) Pub. Date: Aug. 8, 2002

(54) Method and apparatus for use in a projection display to prevent ghost images on or near a projected image

(76) Inventor: Sze-Ke Wang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,615

(22) Filed: Jan. 25, 2002

(30) Foreign Application Priority Data
Feb. 2, 2001 (TW) 090102308

(51) Int. Cl. G03B 21/14

(52) U.S. Cl. 353/69

(57) ABSTRACT

A method for use in a projection display to prevent ghost images on or near a projected image, wherein the projection display comprises an illumination system and an imaging system, the illumination system including a light source; an illumination module; a field lens; and a reflection device, the imaging system includes the field lens; an imaging module including a stop; and a screen, and the method comprises the step of applying a multi-layer anti-reflection coating on the first surface S1 of the field lens facing the light beam coming from the light source and the step of applying a dielectric coating on the surface S2 of the imaging module facing the light beam coming from the field lens. The multi-layer anti-reflection coating is used for reducing the reflectance of the surface S1 with respect to the visible light by sacrificing a little of red light to get better transmittance of green and blue light so that the green and blue light pass the field lens and the red light incident on the surface S2 is reflected by the dielectric coating on the surface S2 and therefore a ghost image is prevented from being formed.

### BACKGROUND OF INVENTION

1. Field of the Invention

The present invention relates to a projection display, and more particularly to a method and apparatus for use in a projection display to reduce or prevent ghost images on or near a projected image.

1. Description of the Related Art

The projection system 10, as shown in FIG. 1, of a prior art projector comprises an optical illumination system 20 and an imaging system 40. The optical illumination system 20 includes a light source 21, an illumination lens module 23, a field lens 30, and a reflection device 25. The imaging system 40 includes the field lens 30, an imaging lens module 41, and a screen 45, wherein the field lens 30 has a surface Al facing the light from the light source 21. With respect to the field lens 30, a front 32 is at the same side as the light source 21. A rear zone 34 and the light source 21 are at the opposite sides respectively. The imaging lens module 41 has a surface A2 facing the field lens 30 and the imaging lens module 41 has a stop 43.

In the light path of this conventional projector, a light beam emitted from the light source 21 passes through the illumination lens module 23 and the field lens 30, is reflected by the reflection device 25, re-passes the field lens 30, and passes through the imaging lens module 41 before being projected onto the screen 45.

Due to that in the projection system 10 of the prior art projector, the field lens 30 is commonly used in the optical illumination system 20 and the imaging system 40, a light beam from the light source 21 to the reflection device 25 can affect the imaging system 40 from the reflection device 25 to the screen 45. Most obviously, for a light beam projected onto the surface A1 of the field lens 30, the surface Al cannot be 100% transparent or absorptive and thus a portion of the light beam can be scattered as light rays passing through the stop 43. The extensions of some of the light rays converge at a point and thus form an image called as a ghost image. As shown in FIG. 2, a screen image includes a normal image N and a ghost image G formed near the periphery thereof.

### SUMMARY OF INVENTION

An object of the invention is to provide a method and apparatus for use in a projection display to prevent ghost images on or near a projected image.

To achieve the above and other objects, the present invention provides a method for use in a projection display to prevent ghost images on or near a projected image, wherein the projection display comprises an illumination system and an imaging system, the illumination system including a light source; an illumination module; a field lens; and a reflection device, the imaging system includes the field lens; an imaging module including a stop; and a screen, and the method comprises the step of applying a multi-layer anti-reflection coating on the first surface S1 of the field lens facing the light beam coming from the light source and the step of applying a dielectric coating on the surface S2 of the imaging module facing the light beam coming from the field lens. The multi-layer anti-reflection coating is used for reducing the reflectance of the surface S1 with respect to the visible light by sacrificing a little of red light to get better transmittance of green and blue light so that the green and blue light pass the field lens and the red light incident on the surface S2 is reflected by the dielectric coating on the surface S2 and therefore a ghost image is prevented from being formed.

### BRIEF DESCRIPTION OF DRAWINGS

The above and other objects, advantages, and features of the present invention will be understood from the following detailed description of the invention when considered in connection with the accompanying drawings below.

FIG. 1 is a schematic view showing the projection system of a prior art projector.

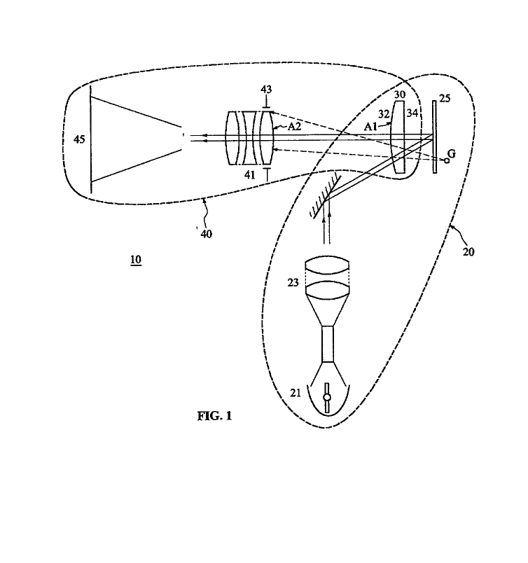

FIG. 2 is a schematic view showing a ghost image generated by the prior art projector.

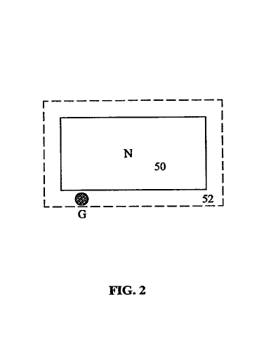

FIG. 3 is a schematic view showing the projection system in accordance with the present invention.

FIG. 4 illustrates the inventive concept of the invention.

### DETAILED DESCRIPTION

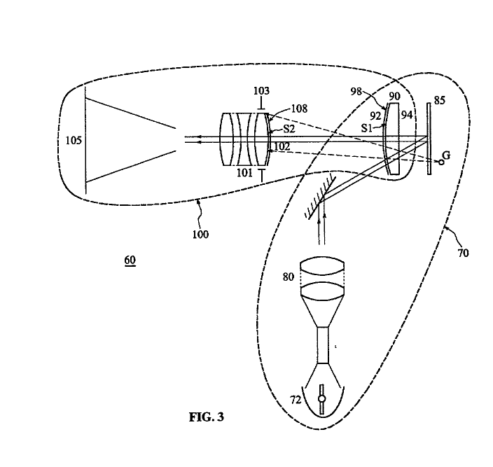

Referring to FIG. 3, an apparatus 60 for use in a projection display to prevent ghost images on or near a projected image in accordance with the invention comprises an illumination system 70 and an imaging system 100, wherein the illumination system 70 includes a light source 72, an illumination module 80, a field lens 90, and a reflection device 85, wherein the illumination module 80 accepts a light beam from the light source 72 and provides illumination for the apparatus 60. The field lens 90 transmits the light beam from the illumination means 80, and the reflection device 85 is used for reflecting the light beam transmitted through the field lens 90. The reflection device 85 may be a DMD (Digital Micro-mirror Device), a reflective light valve, or a reflective LCOS (liquid crystal on silicon).

The imaging system 100 comprises the field lens 90 commonly used in the illumination system 70, an imaging module 101 including a stop 103 for forming an image from the light beam irradiating from the field lens 90, and a screen 105 for displaying the image from the imaging module 101. The field lens 90 has a surface S1 facing the light beam coming from the light source 72. The imaging module 101 has a surface S2 facing the light beam coming from the field lens 90.

A method for use in a projection display to prevent ghost images on or near a projected image in accordance with the invention comprises the step of applying a multi-layer anti-reflection coating (ML AR coating) 98 on the surface S1 of the field lens 90 facing the light beam coming from the light source 72 and the step of applying a dielectric coating 108 on the surface S2 of the imaging module 101 facing the light beam coming from the field lens 90. The ML AR coating 98 is used for reducing the reflectance of the surface S1 with respect to the visible light wave range by sacrificing a little of red light to get better transmittance of green and blue light.

Moreover, the red light incident on the surface S2 is reflected by the dielectric coating 108 and therefore ghost images can be prevented. The multi-layer anti-reflection coating may be made of magnesium fluoride (MgF₂), titanium dioxide (TiO₂), or silicondioxide (SiO₂).

Due to the property of the dielectric coating 108, the red light slantwise incident on the surface S2 is reflected and the visible light reflected from the reflection device 85 and orthogonally incident on the surface S2 passes the imaging module 101 and is not affected by the surface S2.

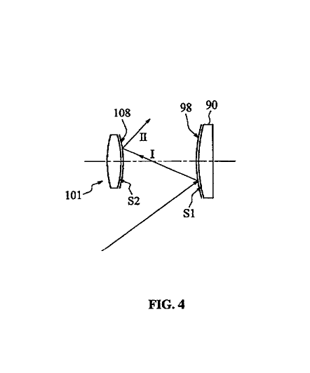

Referring to FIG. 4, the ML AR coating 98 on the surface S1 reduces the main reflective light of green and blue colors and only reflects red light 1. The dielectric coating 108 on S2 reflects the red light 1, which otherwise can generate a ghost image, into a reflective beam II. The main light beam reflected from the reflection device 85 is not affected and is independent of its indent angle.

While the present invention has been particularly described, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An apparatus for use in a projection display to prevent ghost images on or near a projected image, comprising an illumination system and an imaging system,
wherein the illumination system includes:a light source;an illumination module that accepts a light beam from the light source and provides illumination for the apparatus;a field lens that transmits the light beam from the illumination means, the field lens having a first surface facing the light beam from the light source and a multi-layer anti-reflection coating on the first surface; and a reflection device that is used for reflecting the light beam transmitted through the field lens, and wherein the imaging system comprises the field lens;an imaging module including a second surface, on which is applied a dielectric coating, facing and relative adjacent to the field lens and including a stop for forming an image from the light beam irradiating from the field lens; anda screen for displaying the image from the imaging module.

2. An apparatus for use in a projection display to prevent ghost images on or near a projected image in accordance with claim 1, wherein the reflection device is a DMD (Digital Micro-mirror Device).

3. An apparatus for use in a projection display to prevent ghost images on or near a projected image in accordance with claim 1, wherein the reflection device is a reflective light valve.

4. An apparatus for use in a projection display to prevent ghost images on or near a projected image in accordance with claim 1, wherein the reflection device is a reflective LCOS (liquid crystal on silicon).

5. A method for use in a projection display to prevent ghost images on or near a projected image, wherein the projection display comprises an illumination system and an imaging system, the illumination system including a light source; an illumination module; a field lens; and a reflection device, and the imaging system including the field lens; an imaging module including a stop; and a screen, and wherein the method comprises the step of applying a multi-layer anti-reflection coating on the first surface Si of the field lens facing the light beam coming from the light source and the step of applying a dielectric coating on the surface S2 of the imaging module facing the light beam coming from the field lens.

6. A method for use in a projection display to prevent ghost images on or near a projected image in accordance with claim 5, wherein the multi-layer anti-reflection coating is made of magnesium fluoride (MgF₂).

7. A method for use in a projection display to prevent ghost images on or near a projected image in accordance with claim 5, wherein the multi-layer anti-reflection coating is made of titanium dioxide (TiO₂) or silicondioxide (SiO₂).

8. A method for use in a projection display to prevent ghost images on or near a projected image in accordance with claim 5, wherein the multi-layer anti-reflection coating is used for reducing the reflectance of the surface S1 with respect to the visible light by sacrificing a little of red light to get better transmittance of green and blue light so that the green and blue light pass the field lens and the red light incident on the surface S2 is reflected by the dielectric coating on the surface S2 and therefore a ghost image is prevented from being formed.
